(19) United States
(12) Patent Application Publication
(10) Pub. No.: US 2021/0309199 A1
(43) Pub. Date: Oct. 7, 2021

(54) R90 BREAK SYSTEM

(71) Applicant: MORTEZA RASHKI, ZAHAK (IR)

(72) Inventor: MORTEZA RASHKI, ZAHAK (IR)

(21) Appl. No.: 15/856,398

(22) Filed: Dec. 28, 2017

(51) Int. Cl. B60T 13/72; B60T 7/04

(52) U.S. Cl. CPC B60T 13/72; B60T 2201/06; B60T 7/045

(57) ABSTRACT

R90 is a system that does not allow gear vehicles to go back without the driver's discretion. R90 also takes the brake pedal when the deviation is more than ninety degrees, while vehicle is out of the driver's control and the vehicle bottom moves forward from its head.

### BACKGROUND OF INVENTION

All gear vehicles in the world return when they are placed in an ascent if the driver does not press the brake pedal. For instance, behind the red lights, which are somewhat high, some unwanted collisions occur between vehicles, or pedestrians or motorcyclists are endanger while they pass between cars.

### SUMMARY OF INVENTION

A general description but more detailed than the abstract of invention and its advantages in comparison with the similar samples.

There are some reasons why the number of gear cars in the world is much more than the automatic one; like 30% less fuel consumption, more vehicle control over driving risks such as rally, as well as lower maintenance costs and amortization, etc. Such advantages in the gear vehicles attract many customers, but one of the problems that have not already been addressed is the problem of reversing all types of light-weight or heavy-weight vehicles at high altitudes which leads the problems such as going back without deriver's discretion behind red lights or forcing deriver to keep his foot on the brake pedal consistently or pushing deriver to pull the hand-brake after each stop.

However, in present system which is shown in the first part, the vehicle will not go back until the deriver chose “R” mode which has been marked on all gears of differential gear and the white light of the vehicle will be turned on. Additionally, like in the neutral gear mode, the driver can get rid of the car by pressing gas pedal. This advantage has been considered in order to give a chance to deriver that he does not force to be in mode of reverse gear in high altitude because of existing this system; as a matter of fact, not only will not driver concern about vehicle returning without his discretion and its subsequent problems, but also he does not have to keep the brake pedal while waiting for the red light to come out, and he does not have to pull the handbrake immediately after hanging off the brake pedal.

The second part of the system, which is named “90”, is a benefit that was recognized after testing the system in various situations. When vehicle which had been equipped with the system deviated; we realized that the same system without adding any other piece in brake pedal can take the brake pedal in deviations of more than ninety degrees. The result is that the system overrides the moment of inertia, that is, the force that prevents you from running at a speed if you stop at once, and this only happens when the vehicle goes out of a ninety degrees angle and this is only possible when the vehicle bottom moves forward from its head due to the deviation.

The reason for the system's activation in this situation is that when the vehicle exceeds the deviation from angle ninety, the wheels turn back at least a full round, while foe the activation of this system, one thousandth of a full round is enough to activates the system and then pulls the brake pedal.

One of the most benefits of “90” system is that the system can be smartly activated in situations that are not predictable and happen in a few seconds and the driver has no decision-making power. Additionally, the system prevents more than ninety degrees of deviation by overriding the moment of inertia, which can lead to consistent rotational movements, and it prevents the vehicle from falling or going back as well.

However, if the driver wants to deflect the vehicle deliberately for some reason, such as performing flashy exercises, it can easily be done by touching the accelerator pedal so that the system is not activated even in the deviation of more than ninety degrees. If your vehicle is at a height, you will be able to deactivate the system by touching the accelerator pedal and you do not need to keep brake pedal or pulling the handbrake, which allows the vehicle to return. Interestingly, by removing the leg from the accelerator pedal, the system will be activated and the brake will be automatically taken.

One of the problems which may be mentioned in terms of safety is that this system will not be activated when the vehicle is moving forward in order to taking the brake pedal. In response, the three most important safety measures is presented which will be definitely addressed the concern adequately.

First, the driver pushes the system off the circuit by touching the accelerator pedal, secondly, the sensor program on the ABS gear of the vehicle is written such that while the speed of the vehicle is more than 15 km, will not be activated and the commands are completely out of the circuit, unless the speed returns to the 15 km again, third, if all parts of the system, either individually or all together are interconnected or connected in any way, will never cause to activate the system impertinently.

For example, the most important of pieces, the electronic valve is alluded. The existing electronic valve, like all other ones, is closed normally, and it opens when we command to electrify it from the system board that leads to open the vacuum way of engine to the booster which is placed in behind the brake and finally the brake pedal is taken.

If for any reason this valve is damaged, then the magnet cannot be magnet and it will not able to overcome the potential of the spring in itself and will not open the path of vacuum to the vacuum booster, so it does not work just when it's damaged, rather than stay active when it's damaged.

### BRIEF DESCRIPTION OF DRAWINGS

FIGS. 1 and 2: display a magnetic sensor mounted on an ABS gear of the vehicle so that it detects the direction of forward or rearward while the wheel is in motion.

FIG. 3: displays the command board that controls the valve.

FIG. 4: displays the electronic valve.

FIG. 5: displays the advanced tube.

FIG. 6: displays a vacuum booster.

FIG. 7: displays a step brake.

FIG. 8: displays a relay which is used in the wiring.

FIG. 9: displays the system wiring map

### DETAILED DESCRIPTION OF INVENTION

R90 is a system that does not allow vehicles to go back without the driver's discretion at any altitudes and the brake pedal is taken by the system instead of the driver, and only with the driver's decision the vehicle returns either by placing the gear in the reverse gear position or without it, so the vehicle is released and turn back by stepping on the accelerator pedal.

Additionally, this system overcomes the moment of inertia which causes to reverse the vehicle after deviations; which means that after more than ninety degrees of deviation, the brake pedal is taken and the vehicle is stopped in order to preventing the vehicle from rotational movements, and returning either at altitude or non-altitude.

This system runs with the idea that:

A drawer with the smallest possible amortization which is mounted on brake pedal and receive the command of activation from one of the car's wheels. This command is given to the drawer when the wheel goes back and only in a few exceptions, when the wheel goes back, the brake pedal is not taken. These exceptions are 1) when the vehicle is in the reverse gear position and the white lights of the reverse gear are on. 2) When the driver's foot is on the accelerator pedal and he presses it a little. 3) When the driver turns off the system from the cabin. 4) When any of the parts break down.

Description of the main parts of the system whose image is attached with the explanation of their functions:

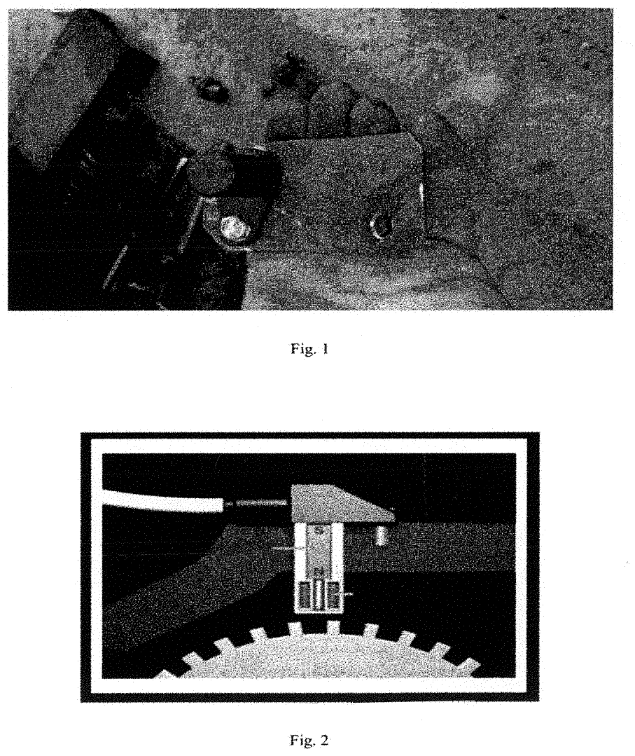

FIGS. 1 and 2 display a magnetic sensor mounted on an ABS gear of the vehicle so that it detects the direction of forward or rearward while the wheel is in motion, and at high speed it can completely inactivate the command.

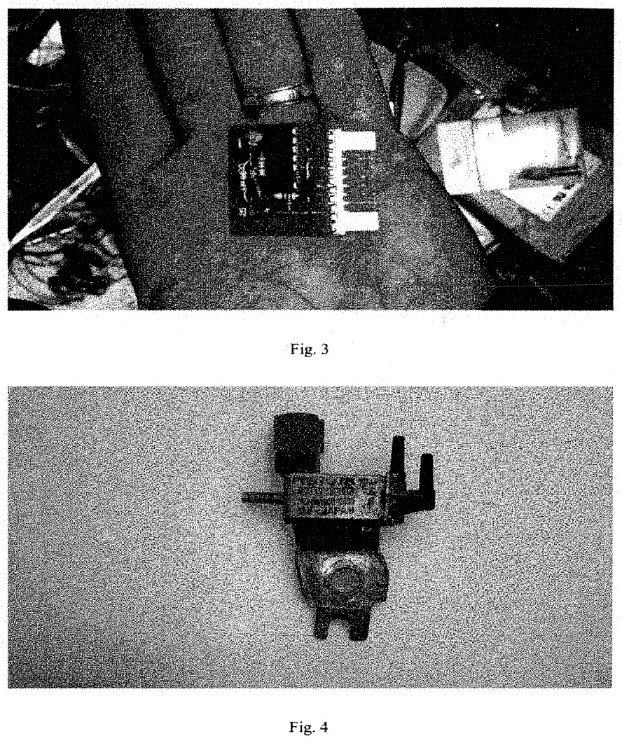

FIG. 3 displays the command board that controls a valve with instructions which it receives from the sensor mounted on the wheel, and if any problem or command comes out of the sensors other than the one ordered, it cancels all commands for greater safety, for example, when the speed of the car in moving forward reaches to 15 km does not give any commands unless the speed of the vehicle again reaches below 15 km. Furthermore, when the two sensor wire sticks to each, all commands is canceled.

FIG. 4 displays the electronic valve which is called the cooler valve in the car is connected and is disconnected with the command of the board that as a result, it opens vacuum path of the cylinder head to the booster and is used to grab the brake pedal or to release the brake pedal.

FIG. 5 displays the advanced tube, which is exist in the motor of vehicle, and is also installed in other parts, such as the regulator of accelerator pedal, and is anti-heat. These tubes are used for piping booster to vacuum of cylinder head, while an electronic valve is placed through this path.

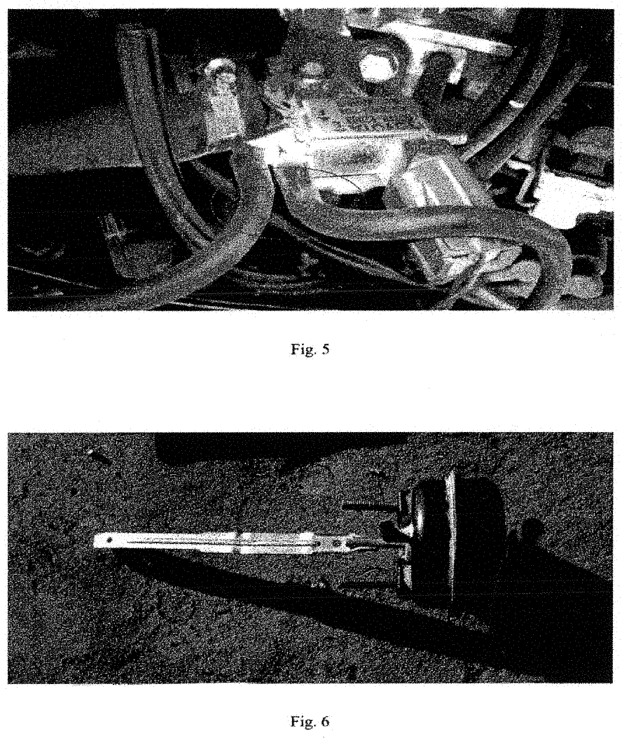

FIG. 6 displays a vacuum booster, similar to that is used in some vehicles, for closing the cooler valve by using a cylinder head vacuum. This piece which is mounted on the rear of the brake pedal from inside the engine is connected to the brake pedal with a flexible soft wire. The reason for using soft wire is making a connection between the brake pedals to the booster. It's important whether or not the booster works; there is nothing under the brake pedal, which is disturbing or dangerous.

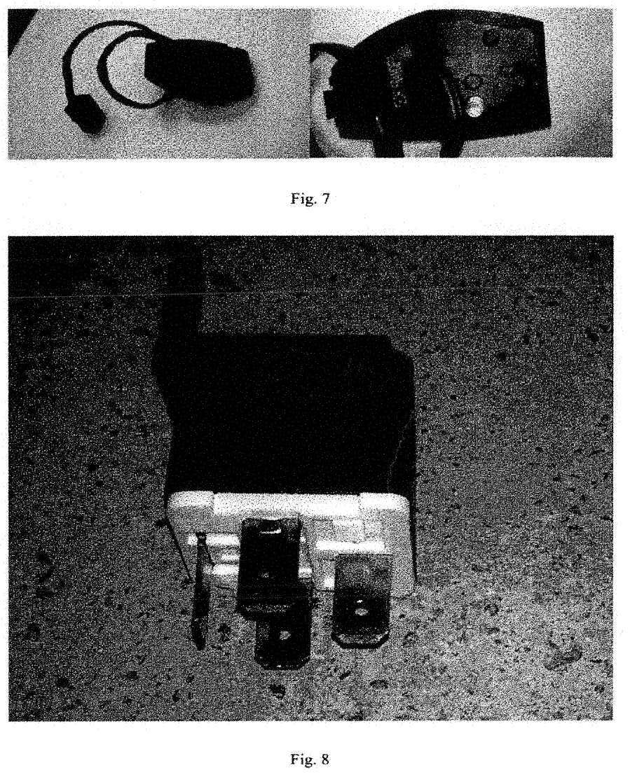

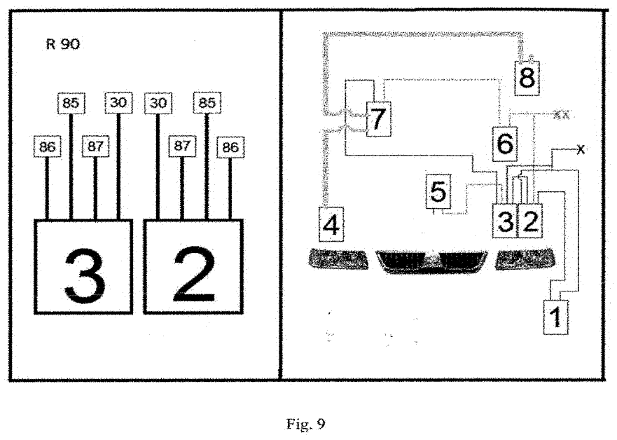

FIG. 7 displays the step brake which is mounted on the accelerator pedal as a lopper of all commands from command broad. Its applications are: 1) when the vehicle is stopped by the system, whenever we step on the accelerator pedal and rev starts to rise; the brake pedal is released and is no longer taken through the system except the vehicle returns while it is not in reverse gear mode. 2) At high altitudes to get rid of the brake pedal without placing the gear in the reverse gear position, so that when you are at an altitude, remove the foot from the brake pedal as soon as the vehicle's wheel returns, the system is activated, but if you wanted to go back whenever you need to do it, without having to put yourself in the reverse gear, it's just enough to touch the brake pedal without stepping on accelerator pedal until the system is inactivated and the vehicle starts to return; thus, wherever it is needed, just by removing the foot from the accelerator pedal, as the wheels turn back, it immediately returns to the circuit and the brake pedal will be stopped instead of you.

Step One: Similar to FIG. 1, we make a base for magnetic sensor to install it on the ABS gears; installing it like FIG. 2. This is a waterproof sensor, and because of its magnetic features, it bales to work under the water and mud, which is already made especially for the vehicles.

Stage Two: We install a suitable vacuum booster on the rear or surface of the brake pedal, which can take the brake pedal through the two positions of the advanced tube by pulling it from the beneath through the link soft wire or from the top with an arm; as a matter of fact, it takes the brake pedal by releasing the path of vacuum of Cylinder head and releases by disconnecting, as shown in FIG. 10.

Step 3: At this stage, by using an advanced tube, we connect the vacuum tube of the booster to the vacuum position in the cylinder head, and in this direction we install a vacuum electronic valve, similar to the one in the car for the cooler, (like the FIG. 11). And for testing, we just need to connect the electric valve to the battery, then the path of vacuum cylinder head is opened to the booster, and the brake pedal is immediately taken and is released immediately by removing. This method of movement in brake pedal is the least possible depreciatory in the world for lack of existing an electric motor.

Step 4: At this point, we wire, so that we install a command-board that we've already written the programs and commands on it and it has a plug as well. This plug has an input power from the vehicle's power which it activates the board and it can be on and off by the key which is embedded inside the cabin. As long as the power supply circuitry is not connected, nothing happens to the vehicle because the electric valve does not reach the electricity to opens the vacuum path of the vehicle and takes the brake pedal.

Of course, one of the features that greatly increase the security of the system is the one that regarding to the electronic valve because it is always closed normally and if it is damaged in any way, it is closed again and it only opens when it is connected to the power and thereby finds the magnetic feature In order to opens the path of vacuum by overcoming the potential power of the metal spring in the electronic valve.

Step 5: At this stage, which is part of the wiring, we install a lopper in a suitable way on the accelerator pedal (FIG. 6), which is a lopper for all commands, even a sensor like the main key in the cabin. Moreover, a wire from the spark plug on the gearbox commands to the board to turn on the white light of the reverse gear while the vehicle in the reverse gear mode. In fact, when the white lights of the reverse gear is turned on, that is, the vehicle is in the reverse gear position, the board commands to turn off the electronic valve by the relay that is mounted on the command line.

Therefore, the output of the plug of electric command-board reaches to the electric valve and the sensor, which takes commands from the sensor and applies on the electronic valve (FIGS. 11 and 12). The result we get from these four steps is that when we activate the board by turning on the key, our system is ready. At this time, the sensor on the wheel, if the car is at a height, alerts the board in order to commands to open the electronic valve. Then, the brake pedal is taken by opening, the vacuum path of the cylinder head to the booster.

And it does not work when: 1) the vehicle is in the reverse gear position and the white lights of the reverse gear are on. 2) The driver's foot is on the accelerator pedal and he presses it a little. 3) The driver turns off the system from the cabin. 4) Any of the parts break down.

1) Preventing Vehicle from Returning with the Smart System which is Named R90:

A vehicle which is equipped with an smart system R90 will never return without the driver's discretion, which means that the system R90 does not allow the vehicle return, as long as the driver places the gear in R mode; that is to say in reverse gear mode. The driver will only need to release the clutch to move the car while he presses the accelerator pedal in order to move. The smart system R90 on the vehicle acts as an extra foot for the driver. In this way, if for any reason when the vehicle wants to go back, the smart system R90 does not allow it. It's no different whether the car is in the gear or not; however, the smart system R90 will be activated.

2) Driving in Traffic with the Smart System R90:

Drivers are driving for hours at heavy traffic while they are not steady for a minute, and they have to slip behind the rest of the cars, and they are stopped frequently. Similar to the second hand of hours that goes forward with each tick; in such a situation drivers will have to keep their foot on hold after each stop. At this time, each leg of the driver is needed, the left foot on the clutch and the right foot on the brake pedal. If the driver feels that the length of stop will be a long time, he will pull the hand brake that he would be able to remove his right foot from the brake pedal. However, if the vehicle is equipped with an smart system R90, there is no need to keep the foot on the brake pedal and even pull the hand brake for preventing the vehicle from returning. But, if the deriver moves slowly, he does not even need to remove the foot from the accelerator pedal for braking.

3) Ease of Driving with the Smart System R90

Regarding the second advantage, driving without an smart system R90 will be very tedious for any driver, so that in a semi-heavy traffic in one hour, the driver at least 100 times slips the vehicle forward a little and he requires hold the foot on the brake pedal or pull a hand brake after each stop; but, with the smart system R 90, the driver at all heights does not even need to hold the brake pedal or pull the hand brake even at one time. With a bit of normal driving experience, the driver will not even need to take brake pedal even for a stop, which means that the driver when he benefits from the smart system R90, at all heights, even once, does not place your foot on the brake pedal unless he tries to slow down the car; so, it causes the driver does not need to remove his foot from the accelerator pedal and take the brake pedal repeatedly in the high altitudes and during long traffic. Besides, when the driver does not need to pull hand brake as often as not, the one foot and one hand of the deriver is always free, which makes driving easy and does not make the driver feel tired.

4) The Comparison Between Automatic Gear Vehicles and Gear Vehicles which is Equipped with the Smart System R90:

Each of the gearboxes of the automatic gear vehicle and gear vehicle has disadvantages and advantages. For example, the disadvantages of automatic gear vehicle can be high price and increasing fuel consumption up to 30% and expensive maintenance costs; on the other hand, the disadvantages of gear vehicles is forcing the driver to hold the clutch and shifting frequently the gear while driving, but with an smart system R90, driving in parts is much easier and safer than driving with an automatic gear vehicle, which we'll mention some of them.

1. When two vehicles one with automatic gears and the other with the conventional gear equipped with smart systems R90 are placed together in a traffic and in the same altitude, driving the conventional gear vehicle with the smart system R 90 will be much easier because the driver moves forward slowly with traffic and does not have to keep the brake pedal, and in the event of long stops, it does not need to pull the hand brake, and he always has one hand and one leg free, but the driver in the automatic gear vehicle while driving in traffic cannot even take a moment to pull the foot off the brake pedal because the vehicle moves forward, and in the event of a long stop, he has to put the vehicle in park mode and put his leg on the brake pedal for every move and put the gear in motion mode.

2. When an automatic vehicle and a gear vehicle which is equipped with an smart system R90 are at a height and both have the intention of returning, the driver of the automatic gear vehicle is required to step on the brake pedal firstly and then put the vehicle in R mode and pull off the brake pedal and hold the brake pedal and turn the gear from R to park mode for stopping again, but the driver in the conventional gear vehicle with an smart system R90 in the height to go back does not need to pull off hand brake, or put the vehicle in R mode and not the need to place the foot on the brake pedal for Stopping after the backward movement, but the only thing the driver needs to do is stepping his foot on the accelerator pedal, so that the vehicle can go back and it is even more interesting that to stop, he does not need to lift his foot and puts on the brake pedal, but just take the foot out of the accelerator pedal to stop the car immediately.

3. Another important advantage that exists in conventional gear vehicles equipped with the smart system R90 is the stopping system which is activated when the vehicle is deviated more than ninety degrees, which is not the case in any automatic gear vehicles made in the world. The R90 brake system operates in deviations in such a way, when the vehicle wants to have rotational movements at any time and for whatever reason, or going back without the driver's discretion, the R90 brake system is activated at first deviation of more than ninety degrees and it will remain active until it completely stops the car. However, the driver can, if necessary, turn off the system by pushing the accelerator pedal and control the car by himself.

5) Reducing Accidents and Road Casualties with the Smart Systems R90

With the smart system R90 in cars, the percentage of traffic crashes coming from the vehicles' returning on sloping roads reaches zero, which means that no vehicles will ever return to the back to hit the rear car, or it will not happen that a human or motorcycle or bicycle will strike the car on a car box when they cross between the car to alert the driver will put his foot on the brake pedal; the smart system R90 is the first and only inventive system in the automotive brake industry in the world, which stops the car from deviations of more than ninety degrees that gives the driver more sense of safety more than ever.

There are many different systems in the world's most advanced vehicles which are designed to prevent from deviation. But their main difference with the smart system R90 is that all those systems prevent from deviation by dividing the force of momentum on the wheels only, and after deviating, they do not do anything, but the smart system R90 operates after the deviation. The difference between the two is the difference between prevention and treatment methods.

We look at an example that has caused millions of deaths to humans, with an smart system. At midnight, a Peugeot Xantia is moving at a speed of 120 km/h when the third cause of road deaths (drowsiness) comes to the driver. The car leaves the road and it will possibly strike a bridge. The driver realizes the dangerous situation by shakes of vehicle and he immediately and hastily turns the steering wheel to the road, while the car is moving round and round, but the driver for some reason like a shock cannot take the brake pedal; as a result of the freedom of the car's wheels; it causes the car to be pulled by force, or it strikes the occupants around the car.

In a few seconds and with a few rotations, the car knocks to the something or it exits the road. But the smart system R90 is activated and takes the brake pedal in the first turning of the vehicle which leads to the car's rotation, and at the 90° angle, exactly where the bottom of the car wants to pass from the front of the car, so it stops the car with any braking system and never lets the vehicle to have successive rotation and prevent vehicle from pulling after the first rotation.

6) Decreasing One of the Signpost's Risk with the Smart Systems R90

One of the rules of driving is that drivers must move on the slope of roads with heavy gear. This item is on the signpost in most of the slope roads with the title “DRIVE WITH HEAVY GEAR”.

First Question: Do you know why you should move on these roads with heavy gear?

Second question: Do you know the role of the smart system R90 on these roads?

Third question: Do you know why most drivers do not comply with this rule?

Answer of the First Question:

As long as the car is moved forward, it's all in the driver's control, but if for any reason, such as a tire bursting, accident, a glide or sleepiness, the driver loses its control and the car begins to circulate and rotate, driver's life depends on four factors:

The first factor: The car does not hit any object all during the deviation.

The second factor: The car does not deviate with the completely free wheel after the deviation, because in this situation, the car will have rotation or it will be stretched until it hits any object.

The third factor: which saves the driver's life, is the same as the signpost commands; that is to say, “DRIVE WITH HEAVY GEAR”. So that when the car is in a heavy gear, the two wheels of the car rotate harder than the other two wheels of it, which makes the vehicle's deviations a little bit harder, then the car is stopped sooner than when the car is moved with the neutral gear. For instance, if a vehicle deflects when it is in the neutral gear mood, it may be stopped after ten rounds of rotation, but if it is in the heavy gear mood, it may be stopped after five to seven rounds of rotation.

The fourth factor: The most effective factor to save derivers' life in such a situation is the smart system R90, which saves the drivers much faster than all the other three factors.

Answer of the second question: The smart system R90 operates on roads with severe slopes, as same as those that do not have slope, which will stop the car in the first turn of more than 90 degrees and in no case will it allow the vehicle to have rotational or tensional movements.

Answer of the third question: One of the reasons why most drivers do not comply with the “DRIVE WITH HEAVY GEAR” rule in slope roads is that the car will have more amortization due to the high engine speed without stepping on the accelerator pedal, and the fuel consumption will significantly increase.

7) Counteracting the Force which Causes Rotational or Tensional Movements with the Smart System R90

If you run fast and you stop suddenly, the potential power will be immediately released in your body after the stop, and it will move you forward a few steps without your intention. The amount of this power depends on your speed and weight. Brake systems are built on all vehicles in order to overcome this power and the smart system R90 is the first automotive brake system in the world that overcomes this potential during rotational, revolving, and tensional movements.

The system R90 can do that perfectly because it stops all cars' wheels after the first deviation of more than ninety degrees. This system is activated precisely at ninety degrees of deviation to allow the deriver have control on his vehicle at the deviations less than ninety degrees.

8) Several Situations where the Vehicle Automatically Stops with the Smart System R90:

When the vehicle is at a height to prevent from returning, such as when you leave the vehicle without pulling hand brake in order to open garage's door.

When you drive back, you never need to brake to stop, because whenever you remove your step from the accelerator pedal the car will be immediately stopped. When one of the four tires of the vehicle bursts and the vehicle is deviated more than ninety degrees, the smart system R90 is activated. When the car glides, the smart system R90 will be active at the first deviation of more than ninety degrees.

When the driver wants to deflects the car by flashy movements, after the first deviation of more than ninety degrees, the smart system R90 will be activated. When the driver turns the steering wheel rapidly to prevent the vehicle from a collision with object, the smart system R90 will be activated as soon as the deviation exceeds ninety degrees.

When the car is moved, if an object or a car collides with it, if the impact on the rear or front of the car from one of the sides is so intense, which it deflects the car, after the first deviation of ninety degrees, the smart system R90 will be activated and the vehicle will be immediately stopped.

When you plan to pull the hand brake and move the steering wheel of the car freely, if the speed of the car is at a level that causes the car to deflect, after the first deviation of more than ninety degrees, the smart system R90 will be activated and the vehicle will be immediately stopped.

When the driver does not want to use a hand brake to stop the vehicle while it turns on, even if the car is in the slopes, the driver with a slight return and releasing the gear from the movement mode can stop the vehicle without pulling the hand brake. When the driver moves forward in the high-traffic heights with a slow pace, the smart system R90 will be activated after each stops.

9) The Difference Between Airbag and the Smart System R90 in Terms of Safety:

Both smart system R90 and airbag are invented to save the life of car users. But there is an important difference between the two and the fact that the airbag is only active once in its entire life, but the smart system R90 is active throughout its lifetime and always operates its duty to save the life of occupants. This means that if you place a car at heights or deflect the car a thousand times a day, then this system will be active a thousand times a day.

10) The Difference Between Hand Brake and the Smart System R90

The hand brake stops only two wheels of the car while the car is moved, but the smart system R90 stops all four wheels. In addition, when driving, the hand brake does not light up rear lights of the car to ensure stop of the vehicle for other cars which are placed behind the vehicle, but the smart system R90 lights up the rear lights in any state that is activated.

11) The Smart System R90 is the Best Alternative for the Hand Brakes

All the time and in all driving conditions, as long as the car is on, you can use the smart system R90, even on slopes, instead of hand brakes, whenever it is needed.

12) Less Amortization of Parts of the Car with the Smart System R90

With smart system R90 in cars, some parts of the vehicle will have less amortization, so some of them are mentioned below:

Hand Brake:

With a smart system R90, the hand brake in cars is only used in two situations: first, when the car is off, and the second when the car is slope roads.

Gearbox:

With the smart system R90, the driver in any circumstances cannot step on the accelerator pedal while the vehicle is returning, so whenever the driver intends to move forward, the car stops completely, which increases the lifetime of the gearbox. Since the gearbox will not have to overcome the potential that pulls the car back to move the car forward.

Clutch Plate, Differential, Etc.

Less amortization for the clutch plate; differential, etc. due to the same explanations as given in the previous paragraph.

13) Medical Benefits of the Smart System R90

The smart system R90 has a lot of medical benefits for stopping the cars in deviations of more than ninety degrees, which is mentioned by two examples.

The first case: When the driver does not notice to car's return at the place, or traffic or in an intersection, the passengers will probably be damaged. The second one: It has been repeatedly happened to every driver, and it happens that when the car is stopped, the deriver looks at the surrounding heavy or light cars, and he suddenly finds out that the car is going back and stepping on the brake pedal. However, he realizes that the car is still going back, while the driver will be shocked, and his heart rate will be increased before he will be certain that his car is fixed and they are the surrounding vehicles which are being moved forward. This condition is so disastrous for many people; nonetheless, a driver who drives only a few days with the smart system R90 always has the confidence of his car at all times that his car will never go back without his discretion.

14) Heavy Vehicles with the Smart System R90

As stated in the patent and approval certificate of the Center for Scientific and Industrial Research of Iran, the smart system R90 can be installed on all lightweight and heavyweight cars of the world, so you can get all the benefits of the smart system R90 in heavyweight vehicles such as trucks, trailers, buses, tractors, and more.

15) The Cost of Equipping Cars with Smart Systems R90

The cost per vehicle is between . . . and . . . depending on the type of vehicle.
Despite all the advantages, this cost is less than the cost of one of the four aluminum rims.

16) Ease of Obtaining a Deriving License with the Car which is Equipped with the Smart System R90

All ladies and gentlemen who plan to obtain driving license could be trained much faster with the smart system R90. Even drivers of heavyweight vehicle who need to obtain an advanced certificate have big problems that it is to drive the car without going backwards. In such a situation, if the vehicle is not equipped with the smart system R90, the driver is required to step on accelerator pedal and release the clutch immediately after removing his foot from the brake pedal, so that the car does not come back, but if the car is equipped with an smart system R90, The driver is not required to move quickly after his foot is removed from the brake pedal, and the car starts to move by stepping on the accelerator pedal. Even for re-stopping it is only necessary to remove the foot from the accelerator pedal, so that the brake is automatically reactivated.

17) Technical Changes in Vehicles with the Smart System R90

Question: What changes would occur in the technical system of the vehicle with the smart system R90?

Answer: The smart system R90 is installed as an accessory on the vehicle without any changes or connections to all other technical vehicle systems, and it is not even connected to them and in the performance of tasks, it is a fully independent device.

18) Measurement Structural Mechanism and Lifetime of the Smart System R90

The smart system R90 consists of two parts: mechanical and electronic, both of which are in a metal box with a length of 20 cm and 8 cm in diameter, on the one side of the box comes a hooded wire similar to the wire of the accelerator pedal or the clutch pedal. It connects to the car's brake pedal and on the other side, two plugs come out, which one attached to the car's battery and the other to a sensor mounted on a part of the wheel.

Explanation of the Mechanical Section:

The mechanical part of the system is an actuator arm connected to a booster similar to the car's brake booster. The booster opens and closes the air vents on most vehicles. The booster of the mechanical arm valves of the cars are very scare because the lifetime of this booster is so high that it does not need to be changed even once in its entire life, except in special cases such as crashes.

Explanation of the Electronic Section:

The electronic section of the smart system R90, which is located in the same box and does not have any relation to the electronic system of the vehicle, is designed to be active if the battery is so weak that it cannot even illuminate the lights; the electronic system is installed in the same box and cannot be stated its lifetime. The only outer part of it is a sensor similar to the sensor on the Pulse gears for the smart system R90. This sensor operates with electromagnetic pulses, which, as a result, only recognizes metals. So it works under water and mud, and if, for any reason, such as crashes, it fails, the electronic board will shut down the system.

19) The Time and Position of the Smart System R90

The total installation time of the smart system R90 on any type of vehicle is less than 30 minutes; To install this system, just find the appropriate space for installing a device in the car, then attach the hooded wire with the lever to the brake pedal and mount the electromagnetic sensor on one of the four wheels and link it to the plug of the box. In the end, the car is equipped with smart system by plugging the battery into the box.

1- An R90 smart system for vehicles, for preventing said vehicles from running backwards; comprising:
A magnetic sensor mounted on an ABS gear of said vehicle detecting a movement direction of wheels of said vehicle while in motion; an electric valve (cooler valve); wherein a signal received from said sensor opens a vacuum path of a cylinder head to a booster, therefore engaging a break.

2- The system of claim 1, wherein said vehicle will never return without a driver's discretion, therefore said system does not allow said vehicle to move backwards as long as a gear is in R mode.

3- The system of claim 2, wherein when said vehicle's clutch is released said vehicle moves as soon as an accelerator pedal is pressed.

4- The system of claim 3, wherein said system acts as an extra foot for said driver.
